(19) United States
(12) Patent Application Publication
(10) Pub. No.: US 2010/0072301 A1
(43) Pub. Date: Mar. 25, 2010

(54) Discharge device

(76) Inventor: Miro Cater, Daytona Beach, FL (US)

Correspondence Address: FLYNN THIEL BOUTELL & TANIS, P.C., 2026 RAMBLING ROAD, KALAMAZOO, MI, 49008-1631, US

(21) Appl. No.: 12/284,242

(22) Filed: Sep. 19, 2008

(51) Int. Cl. A62C 11/00

(52) U.S. Cl. 239/333

(57) ABSTRACT

A discharge device for a liquid pharmaceutical medium has a reservoir for storing the medium, a pressure generator for pressurizing the medium, a discharge opening for discharging the medium and a discharge valve with a valve seat and a valve body movable relative to the valve seat between an open position and a closed position.

An electrical valve actuator is provided through which a force can be applied to the valve body through an electrical valve control current.

### FIELD OF APPLICATION AND PRIOR ART

The invention relates to a discharge device for a liquid pharmaceutical medium having a reservoir for storing the medium, a pressure generator for pressurizing the medium, a discharge opening for discharging the medium and a discharge valve with a valve seat and a valve body movable relative to the valve seat between an open position and a closed position.

The invention also relates to a method for discharging a liquid pharmaceutical medium by means of a discharge device and a method for manufacturing a discharge device.

Numerous different such discharge devices are known from prior art. They are used for the discharge of pharmaceutical media, which is understood to mean in conjunction with the present invention substances which, for medical purposes, are supplied into or onto the body of a user. Such discharge devices are more particularly usable for nasal or ophthalmic purposes.

Such discharge devices have a reservoir in which the pharmaceutical medium is initially stored. From said reservoir a partial volume of the medium is delivered for discharge purposes and is placed under pressure by means of a pressure generator. The pressurized medium is then delivered through a discharge opening into or onto the user's body part to be treated. The discharge valve provided is normally used in order to initially stop the medium pressurized in the pressure generator from escaping through the discharge opening. Only when certain boundary conditions have been achieved, particularly on reaching a constructionally based discharge pressure is the discharge valve opened in order to ensure access to the discharge opening, so that then the partial medium volume is discharged.

In the case of such discharge devices the dosage of the medium to be discharged is generally determined by means of the pressure generator. The pressure generator supplies pressure to the partial medium volume constructionally predetermined by the dimensions of the pressure generator. Said partial volume is discharged during each discharge process. The discharge valve does not itself influence the discharged volume and instead merely serves to ensure a desired discharge characteristic, in that it only opens as from a given fluid pressure in the medium.

A problem with such constructions is that even in the case of a high standard with respect to the manufacturing method tolerances on the pressure generator lead to varying discharge volumes. This effect becomes ever more serious as the volume to be discharged decreases, because the unavoidable imprecisions are then more marked.

### Problem and Solution

Therefore the problem of the invention is to further develop such a discharge device in such a way that the discharge of the medium and in particular the discharged volume can be better influenced. A further problem is to provide a method for the discharge of a medium, which ensures higher influenceability of the discharge characteristic.

In order to solve the set problem, according to the invention the discharge device is supplemented by an electrical valve actuator by means of which a force can be indirectly applied to the valve body through an electrical valve control current.

The valve actuator is constructed in order to supply a force to the valve body relative to the valve seat, said force being preferably dosable via the electrical valve control current.

The discharge valve which is consequently influenceable by means of the valve actuator is according to the invention provided in an area of the discharge device, whose content can be pressurized by the pressure generator. In the simplest case the discharge valve can merely serve during the putting into operation of the discharge device to vent said area by opening the same before air is forced through the valve by means of the pressure generator. In particular, a design is also covered in which the discharge valve is provided between the pressure generator and the discharge opening and can therefore control the medium flow to the discharge opening.

Preferably the medium passes out directly in the form of individual droplets, which are formed by rapid opening and closing of the discharge valve, which is ideal for ophthalmic applications. For producing a use-specific, optimum spray pattern it is also possible to select an adapted flow geometry at the discharge opening, which brings about turbulence, atomization or the like and which is advantageous for topical, nasal or oral applications.

The electrical valve actuator is preferably constructed in such a way that it can transfer the valve body into its open position and its closed position without further force application means. Thus, solely by means of a corresponding control unit, which is constructed for controlling the valve actuator, it is possible to start and finish the discharge process. Thus, through the planned control of the valve actuator a volume of the medium can be discharged, which is much smaller than the medium pressurized by the pressure generator. The imprecision with respect to the volume delivered by the pressure generator and which has been pressurized, consequently does not directly appear in the discharged medium volume, because said discharged volume is solely dependent on the opening and closing of the discharge valve and not the pressurized volume. The electrical valve actuator also allows unconventional discharge characteristics, such as e.g. a pulsed discharge, in which as a result of repeated discharge valve opening and closing in a rapid sequence individual medium droplets can be delivered, as well as a discharge with a reduced discharge pressure, in which the discharge valve is only slightly opened so as to bring about a constricting effect. A further aim for a discharge device with an inventive electrical valve actuator is that the discharge pressure can be influenced in a targeted manner, which makes it possible to have an identical construction of discharge devices for different purposes and which are only specifically adapted with regards to the control of the valve actuator.

The discharge valve can be constructed in such a way that a valve body movement is solely possible via the electrical valve actuator. With such a construction the valve body can only be removed from a preferably closed rest position by the valve actuator. Other influencing parameters such as the fluid pressure of the medium can only be included through detection by a control unit using corresponding sensor means, said control unit opening and/or closing the discharge valve by means of the valve actuator as a function of said parameters. However, the electrical valve actuator can also be designed as one of many influencing means for applying a force to the valve body. With such a design it becomes possible to supplement the other influencing means through the electrical valve actuator, e.g. in order to carry out a precision adjustment of the discharge characteristic.

The discharge valve can be constructed in such a way that a force can be applied to the valve body through the fluid pressure of the medium in a valve chamber associated with the discharge valve and in the direction of its open position.

In said construction the medium in the valve chamber is able to displace the valve body towards its open position by means of a pressure surface on said valve body when the fluid pressure is sufficiently high. Thus, the discharge valve can be opened independently of an activation of the electrical valve actuator, in that under pressure the medium forces the valve body into an open position. This can advantageously be combined with the electrical valve actuator, e.g. in that the opening process is brought about solely or preponderantly by the fluid pressure and a subsequent closed state is brought about following medium discharge by the electrical valve actuator counter to the fluid pressure in the valve chamber. This makes it possible in the manner known from the prior art to start the discharge process on reaching a predetermined minimum pressure and to terminate it following a discharge time interval, although at this time the fluid pressure is in unchanged form still above said opening pressure. In conjunction with a discharge valve transferable by fluid pressure into its open state, the valve actuator can also advantageously be used for modifying the opening pressure by applying a force to the valve body in the closed state. Thus, only at a very high or already at a very low pressure in the valve chamber does the discharge valve pass into the open state.

More particularly for maintaining the closed state of the discharge valve with the latter is preferably associated a valve spring mechanism by means of which the valve body can be supplied with a spring force in the direction of its closed position. In conjunction with the present invention the spring mechanism is understood to mean any force applying means functioning without an external energy supply and by means of which it is possible to permanently supply a force to two components relative to one another. Force application can e.g. be brought about by means of permanent magnets mutually oriented with identical poles. However, it is particularly advantageous to use a mechanical spring, particularly a helical spring, through which a force is applied to the valve body. The valve spring mechanism ensures that in an unused rest state the discharge valve remains with the discharge device in its closed position. The valve spring mechanism preferably forces the valve body with an average pressure of at least 5 MPa onto a circumferential contact area against the valve seat so as to create a germ barrier. The valve spring mechanism can in particular be used in conjunction with the above-described discharge valve, which can be directly transferred by the fluid pressure in the valve chamber into an open state. The valve spring mechanism is decisively responsible for the necessary opening pressure of the medium. The valve actuator can advantageously be used for correcting variations of the spring force compared with a desired spring force. The spring force of the valve spring mechanism varying between individual discharge devices can be brought to a uniform level at least in the relevant deflection position of the valve spring mechanism by supplementing by the valve actuator force acting on the same or opposite directions.

With regards to the design of the electrical valve actuator, in the simplest case for moving the valve body it can comprise an electric motor or an electrical linear actuator. For example accompanied by the interposing of a gear or some other converter, it is possible to operatively couple the same to the valve body.

However, a discharge device is considered particularly advantageous in the case where the electrical valve actuator has an actuating coil provided for producing a magnetic field through the electrical control current and a counterbody movable relative to the valve actuating coil and to which a force is applied relative to the latter by means of the magnetic field, the counterbody or valve actuating coil being fixed with respect to the valve body.

Through this design it is possible to bring about a movement of the counterbody relative to the valve actuating coil using Lorentz force. By fixing the counterbody or valve actuating coil on the valve body, it is possible to supply the Lorentz force to said valve body. As a function of the current direction in the coil force applications can take place both towards the closed position and the open position. By fixing the current intensity it is possible to precisely define the force application and/or displacement of the valve body. The counterbody is preferably constructed as a permanent magnet or alternatively as an electromagnet in order to increase the coil current effect. In particular, use can be made of a plastic-bound magnetic material, which even makes it possible to integrally construct the counterbody and valve body. The counterbody can be firmly connected to the valve body, whereas the coil is fixed relative to the valve seat and at least partly surrounds the counterbody. Alternatively, the valve actuating coil can be provided in fixed manner on the valve body and can move relative to a fixed permanent counterbody during the application of current to the valve actuating coil. With regards to its operation said second variant corresponds to an electrodynamic loudspeaker. Its particular advantage is the low valve body mass due to the low coil mass and which allows particularly rapid valve opening and closing.

An alternative to the construction of the valve actuator with a valve actuating coil involves the valve actuator having a valve piezoactuator controllable by the valve control current for applying a force to the valve body. On being subject to the valve control current, said valve piezoactuator changes its extension and this can be used for displacing the valve body. The valve piezoactuator preferably has a piezo-stack in order to make possible a maximum deflection. As the deflection of a valve piezoactuator is small compared with the deflection of a counterbody relative to a valve actuating coil, preferably there is in addition a transfer mechanism for lengthening the path, e.g. a pivotable lever, which is pivotably mounted and is fixed on the one hand to the valve body and on the other to the piezoactuator and by means of which the piezoactuator extension is transferred in reinforced manner to the valve body.

According to a further development of the invention a valve measuring device is provided and is constructed for detecting a displacement of the valve body relative to the valve seat. Said valve measuring device is so designed that on connection to evaluation electronics it can determine whether the valve body moves relative to the valve seat and/or where said valve body is located relative to said valve seat. The precise valve body position can also be determined in the case of a valve measuring device which only detects the valve body movement, in that starting from a known position a displacement time is established allowing a calculation of the valve body position whilst including the forces acting on the valve body and whose magnitude is known.

In the simplest case the valve measuring device can be used for carrying out a function check on the discharge device. By means of the valve actuator a valve body displacement is brought about and by means of the valve measuring device it is established whether the intended displacement has occurred. The valve measuring device can also be used in order to determine and optionally support a valve body movement brought about in some other way. Thus, the valve measuring device can detect a valve body displacement as a reaction to an increased fluid pressure in the valve chamber and can consequently support the valve opening process through the valve actuator and/or can move the valve body into its closed position through the valve actuator at the end of a given time interval following the opening of the valve.

The valve measuring device is particularly advantageous for determining the discharge device-specific parameters with respect to the discharge valve. Admittedly the different discharge devices of the same type are always manufactured in the same way. However, non-uniform discharge valve characteristics can arise, e.g. through differences concerning the spring force of a valve spring mechanism or with regards to frictional forces which oppose a displacement of the valve body relative to the valve seat. These auxiliary forces differing from one another in the case of each discharge device and which act in or counter to the direction of the force application through the valve actuator, can be detected by means of the valve measuring device. As a function of the valve body mass its force of inertia must be incorporated on determining/calculating the auxiliary forces. In the simplest case the individual auxiliary forces, i.e. in particular the spring force and frictional force, are determined as a combined auxiliary force rather than individually. Admittedly the spring force is not constant, but for the normally limited valve body travel preferably below 0.5 mm and in particular below 0.2 mm, can be assumed as constant.

It is e.g. possible by measuring the deflection of the valve body in the case of a clearly defined force opposed to the spring force to establish the characteristics of the spring mechanism. It is also possible through a time measurement during the transfer from the open to the closed position to establish how high the auxiliary forces opposing the valve body movement happen to be, because they influence the transition period. The time measurement can in particular be used for calculating the average speed of the valve body during transfer from the open to the closed state or vice versa, which allows the determination of the auxiliary forces, particularly the frictional and spring forces, when the power applied for this is known. Since for this purpose the path covered must be known, the movement preferably takes place between two stops, which define the freedom of movement of the valve body in the open and closed position.

The valve measuring device is preferably controlled in such a way that the measurement takes place several times in succession and preferably at least three times in succession, so that measuring errors and fluctuations can be compensated. By measurements in opposite directions during valve body movement, it is possible to also determine the spring force and frictional force in isolation. The discharge de-vice-specific influencing factors concerning the valve body movement determinable in this way by the valve measuring device can be compensated following detection by the valve actuator, so that there is a preset discharge valve behaviour. Thus, a spring force, which is lower than the desired spring force, can be compensated in that by means of the valve actuator an additional force component can be brought about in the direction of the closed position. As a result the opening pressure of the medium, at which the valve body is moved towards its open position, can be precisely defined. The adaptation of the force brought about by the valve actuator as a function of the result of the measurement by the valve measuring device can take place by means of a recorded formula system. Alternatively for this purpose a table can be recorded in the discharge device memory which can e.g. be associated with the result of said time measurement of a force to be brought about by the valve actuator.

As an alternative to such a compensation, the detected values can be included in a discharge process in order to e.g. adapt the opening time of the discharge valve for bringing about a predetermined discharge volume and this will be explained in greater detail hereinafter.

It is considered particularly advantageous to have a valve measuring device provided with a valve measuring coil, which is constructed for determining the movement of a counterbody provided on the valve body. With such a design, through the movement of the preferably permanent magnetic counterbody use can be made of the voltage induced in the valve measuring coil in order to detect the displacement of the counterbody and therefore the valve body. The induced voltage is dependent on the magnetic field, the valve measuring coil and the counterbody speed. The counterbody is preferably identical to a counterbody which can be used by a valve actuating coil for moving the valve body. When using a measuring coil as a measuring device it is particularly advantageous if a determination only takes place as to whether the voltage induced by the valve body movement is higher than zero, i.e. whether a movement exists. The information derivable therefrom as to how long the valve body is moved, in itself enables conclusions to be drawn concerning auxiliary forces, without requiring for this purpose an evaluation of the level of the induced voltage. As a function of the nature of the evaluation, a complicated evaluation of the induced voltage level can be avoided. Like the valve actuating coil the valve measuring coil can be fixed with respect to the discharge valve casing or fixed with respect to the valve body.

According to alternative developments of the valve measuring device, the valve body displacement can be detected by a piezosensor.

It is considered particularly advantageous if the valve actuator is constructed for applying a maximum force to the valve body which exceeds the spring force acting in the direction of the closed position. As a result the discharge valve can be transferred into the open state counter to the spring force and without there being a fluid pressure in the valve chamber forcing the valve body into the open position. This in particular makes it possible to open the discharge valve solely through the valve actuator, so that following the production process air present in the flow path between the pressure generator and discharge opening can be removed. For this purpose the discharge valve is opened and an air pressurization takes place in order to force the air through the discharge valve and out of the flow path.

In a particularly preferred development of the invention a flow limiter is placed between the pressure generator and the discharge valve.

In conjunction with the present invention, the term flow limiter is understood to mean a section of the liquid path between the pressure generator and the discharge opening, which offers a higher flow resistance to the other components on the liquid path. For this purpose the flow limiter preferably has a construction or is constructed as a thin channel through which with the prescribed pressures in the discharge device only a limited volume flow can flow through on either side of the flow limiter, said volume flow corresponding to the medium quantity to be discharged. The flow limiter forms in the liquid path between pressure generator and discharge opening a flow resistance representing at least 50%, preferably at least 80% and in particular preferably at least 90% of the total flow resistance between pressure generator and discharge opening. This can in particular be obtained by a particularly small free cross-section, because the cross-sectional surface quadratically enters the flow resistance of the flow limiter. The cross-sectional surface is preferably less than 1 mmý, preferably less than 0.5 mmý. Through the choice of a suitable and in particular simple geometry, e.g. through the construction of the flow limiter as a thin connecting channel, or through the determination of the flow resistance by tests and measurements, it is easy to calculate or establish the flow resistance of the flow limiter. As the volume flow through the flow limiter is proportional to the pressure difference between the two ends of said flow limiter, in the case of a known flow resistance and known differential pressure it can be calculated which volume flow, i.e. which liquid flow per time unit, flows through the flow limiter. As a result of a construction in which the flow resistance of the flow limiter is responsible for the preponderant part of the flow resistance from the pressure generator to the discharge opening, it is ensured that the volume of the medium flowing through the flow limiter in a given time and calculatable by means of said pressure difference corresponds to the discharged volume.

With the knowledge of the flow resistance of the flow limiter and the pressures on either side of said flow limiter, it is possible to calculate the volume flow through the flow limiter. If it is ensured that the pressure ratios on either side of the flow limiter do not change significantly during a discharge process, it is possible to obtain a predetermined dosage of the discharged medium in a very precise manner on the basis of an adapted discharge valve opening time.

Particular preference is given to a design in which a pressure chamber, whose volume can be reduced by the pressure generator and which is associated with the latter, as well as a valve chamber associated with the discharge valve are provided, the flow limiter being placed between the pressure chamber and the valve chamber.

The pressure chamber and valve chamber are particularly suitable for producing clearly defined pressures making it possible to precisely establish the volume flow on the basis of the pressure difference, the viscosity of the medium and the flow limiter geometry. In the case of the pressure chamber as a result of a corresponding pressure generator design it is possible to ensure that the same pressure is always applied to the medium in the pressure chamber. In the case of the valve chamber it is also possible to produce a clearly defined pressure and this with particular advantage takes place in that the discharge valve is constructed for opening at precisely said fluid pressure. This ensures that the predetermined pressure in the valve chamber is not exceeded. To ensure an opening of the discharge valve as a function of the fluid pressure, the pressure produced in the pressure chamber by the pressure generator must be higher than the discharge valve opening pressure resulting from the design. Both for the pressure chamber and the valve chamber it must be borne in mind that the pressures prevailing there during a discharge can also be influenced by the valve actuator or a pump actuator in order to bring about a previously defined pressure difference during discharge.

Besides a design in which clearly defined pressures are produced in the pressure chamber and valve chamber as a result of design measures, it is also possible through a targeted calculation or determination of the actual pressure in the pressure chamber and/or valve chamber to estimate the magnitude of the pressure difference and to use the latter when calculating the discharge valve opening time. This also permits a precise estimate of the volume flow through the flow limiter.

In a further development of the invention the flow limiter has a connecting channel with an at least zonally uniform cross-section. This design can be produced with particular ease and as a result of the Hagen-Poiseuille Law allows a particularly simple flow resistance calculation. However, such a connecting channel is also advantageous because it can be easily produced and because it particularly adequately ensures a laminar medium flow, so that proportionality exists between the volume flow and pressure difference on either side of the flow limiter. The section with the uniform cross-section is so constructed that it gives rise to at least 80% of the flow resistance of the flow limiter. The cross-sectional surface of the connecting channel is preferably below 1 mmý and with particular preference below 0.1 mmý.

The pressure generator is preferably constructed as a positive displacement pump and has a volume-variable pressure chamber and a pump actuator by means of which the pressure chamber volume can be influenced.

Said positive displacement pump is constructed so that it can be supplied with medium from the reservoir. It is particularly advantageous to use a piston pump or a bellows pump, the pumps being preferably constructed in each case in such a way that on reducing the pressure chamber volume initially the connection to the reservoir is interrupted and then pressurization takes place of the medium in the pressure chamber. In conjunction with the present invention the pump actuator is considered to be those components which indirectly bring about the pressure chamber volume change. In the case of a piston pump, the pump actuator is constituted by those components by means of which a force can be applied to the piston for reducing the pressure chamber volume.

It is particularly simple to have a design where the pump actuator is constructed as a manually actuatable pump actuator. Pressurization of the medium in the pressure chamber consequently takes place with an energy which is manually applied by a user. This allows particularly simple and inexpensive designs. Preferably the pump actuator has a pump spring means, which can initially be manually tensioned and which is constructed in such a way that following release during its relaxation brings about a pressure chamber volume reduction. As a result of such a design with a manually tensioned pump spring means it is possible to have a user-independent pressurization of the medium in the pressure chamber. The energy applied by the user is not directly used in immediate manner for pressurizing the medium. Instead it is initially stored as spring energy in the pump spring means and then, without further intervention on the part of the user, following release is used for pressurizing the medium in the pressure chamber.

It is particularly advantageous if the pump spring means tensioning process takes place through the movement of a component of the discharge device, which in any case must be moved for transferring the discharge device into a use state. For example, it is possible to provide a pivotable protective cap or such a cap movable in some other way relative to the discharge device casing and which prior to discharge device use must be opened and which during the opening brings about a tensioning of the pump spring means by a corresponding operative coupling.

As an alternative to a manually actuatable pump actuator the latter can also be constructed as an electrical pump actuator, which is constructed for modifying the pump chamber volume by means of an electrical pump current.

Pump actuation with an electrical pump actuator more particularly allows a reproducible pressurization of the medium. Pressurization can be brought about by a force which can be accurately dosed as a result of its electrical origin. Particular preference is given to a design where the electrical pump actuator is provided for the displacement of a piston which defines the pressure chamber.

As in the case of the discharge valve body the electrical actuator can be implemented by an electric motor or a pump piezoactuator and preferably by means of a gear or a lever force is transferred from the motor or piezoactuator to the pressure generator or its piston. However, it is considered particularly advantageous to have an electrical pump actuator having a pump actuating coil provided for producing a magnetic field through the electrical pump control current and a counterelement to which a force can be applied relative to the pump actuating coil by means of the magnetic field and which is movable relative to the pump actuating coil. The preferably permanent magnetic counterelement or the pump actuating coil is so constructed and/or positioned that the pressure chamber volume can be modified by a movement of the counterelement relative to the pump actuating coil.

As for the construction of the discharge valve with an electrical valve actuator, also in the case of the pump actuating coil it is preferable that the counterelement is movable for modifying the pressure chamber volume, whereas the pump actuating coil is fixed. However, alternatively, it is also possible here for the pump actuating coil to be movable and e.g. to be secured on the piston of the piston of the pressure generator, whereas the counterelement is fixed.

In a further development of the invention a pump measuring device is provided and is constructed for determining the state of the pump actuator. Like the valve measuring device, said pump measuring device can be constructed in such a way that it determines whether at present there is a pressure chamber volume change, e.g. through a piston movement. However, it can also be constructed in such a way that it determines the position of a piston of a piston pump or the compression state of the bellows of a bellows pump. The pump measuring device is so constructed that it can transmit to a control unit by means of electrical signals the detected data. The function of the pump measuring device like that of the valve measuring device is in the simplest case the possibility of carrying out a function check. The pump measuring device also makes it possible to detect auxiliary forces such as e.g. frictional forces which during pressurization of the medium oppose the force of the pump actuator, so as to compensate the corresponding forces through the pump actuator or, to include the same when calculating an opening time period. A particular advantage of the presence of a pump measuring device is that it can be used for checking the initial filling state of the discharge device. This is understood to mean the filling of the liquid path from reservoir to discharge opening. As a correct discharge process with a clearly defined discharge quantity is only possible when the air has been removed from the pressurized area, in the case of such discharge devices normally initially air is removed from these areas using the most varied measures. The pump measuring device permits a check of this state, in that with the discharge valve closed the pressure chamber volume is reduced. However, if such a volume reduction is no longer possible due to the incompressible character of the medium, this is a sign that all the air has escaped.

The pump measuring device can have a pump measuring coil which is constructed for determining the position of a component associated with the pump actuator and which can be moved in order to influence the pressure chamber volume. With regards to its operation, the pump measuring coil corresponds to the valve measuring coil. It allows the determination of the position of the pump measuring coil relative to a counterelement, which is e.g. secured to a position-variable piston during the pressure chamber volume reduction. This element is preferably constructed as a permanent magnet.

With regards to the pump actuator and pump measuring device the advantages and further developments described hereinbefore relative to the valve actuator and valve measuring device once again apply, provided that they do not relate to the specific characteristics of the discharge valve.

In a further development of the invention a pressure sensor is provided in the pressure chamber and/or valve chamber. Such a pressure sensor allows the direct determination of the pressure in the given chamber. In the case of a pressure sensor in the valve chamber it can e.g. be used for causing the electrical valve actuator to open the discharge valve as soon as a limiting pressure is exceeded. In conjunction with the above-described flow limiter, pressure sensors permit a precise determination of the liquid volume flowing through the flow limiter. Even in the case of varying pressures in the pressure chamber or valve chamber the volume flow which also changes as a result thereof can be permanently monitored and therefore the discharged overall volume calculated. The pressure sensors can be used in order to replace the valve measuring device and pump measuring device in connection with the function of detecting auxiliary forces on the valve body or piston, because the knowledge of said auxiliary forces is not vital when directly measuring the pressures. However, designs are also covered where measuring devices are provided on the valve and/or pump and additionally there are pressure sensors for monitoring the pressure in the pressure chamber and/or valve chamber. With such constructions the different results of the measuring devices and pressure sensors can be used for obtaining particularly reliable information concerning the prevailing pressures. Pressure sensors which can be used are e.g. piezoelectric pressure sensors, capacitive pressure sensors and inductive pressure sensors.

In a further development of the invention the discharge device has a flow sensor, which is preferably located between the pressure chamber and valve chamber. The flow sensor determines the liquid quantity discharged. Thus, on reaching a desired discharge volume the discharge valve is closed by the valve actuator. Apart from positioning between the pressure chamber and valve chamber, the liquid flow measuring device can also be located between the discharge valve and discharge opening.

An inventive discharge device preferably has a control unit permitting the control of the valve control current and/or pump control current and/or the evaluation of the output signals of the pump measuring device and/or valve measuring device. The control unit is primarily used for evaluating the sensors and measuring devices provided in the discharge device and the actuation of the electrical valve actuator and/or electrical pump actuator. The control unit is preferably constructed for performing the subsequently described operating methods.

The control unit is preferably also constructed for counting the discharge processes, so that at all times data exist concerning the reservoir liquid level. The control unit is preferably also connected to input/output means, e.g. a display for outputting state or status messages and/or key switches and for determining control actuations such as a starting actuation triggering the discharge process. The control unit is preferably constructed in such a way that it can carry out a discharge process by means of the pump actuator and/or valve actuator. The control unit preferably stores the discharge time, so as to subsequently prevent for a predetermined blocking time any further discharge process. The control unit can in particular also be used in order to file in a memory data concerning the discharge processes performed and from which said data can subsequently be read for checking the use of the discharge device.

The invention also relates to a method for discharging a liquid pharmaceutical medium by means of a discharge device, a discharge process involving three steps. Firstly the medium within a pressure chamber is subject to a pressure generation with a pressure p1. Then a discharge valve is opened for medium discharge purposes. When an opening time t has elapsed, the discharge valve is closed again by an electrical control signal in order to terminate the medium discharge.

The special nature of this discharge process is that the discharge valve is closed by an electrical control signal. An electrical control signal in conjunction with this method is understood to mean a change to a control current used for controlling the discharge valve. Closing the discharge valve by control signal can consequently also take place by removing a previously applied control current. Through the targeted closing of the discharge valve it is possible to discharge a volume of the medium which can be smaller than the volume pressurized in the pressure chamber. The discharge valve does not close only when the pressurized volume has been completely or almost completely discharged and the medium pressure consequently drops and instead this takes place as soon as the electrical control signal has been transmitted by a control unit to the discharge valve. Besides closing the discharge valve by means of a control signal, the discharge valve can also be opened by such a control signal. This makes it possible to completely time-free the medium discharge in the opening time period t from the pressurization of the medium in the pressure chamber. Thus, medium discharge can start and finish in reaction to the operation of a key switch on the discharge device as soon as the desired medium quantity has been discharged.

It is particularly advantageous if in the second step, on reaching a predetermined medium opening pressure p2, the discharge valve is opened, said pressure being lower than p1. Preferably this takes place directly through the medium fluid pressure. As a result of such a design the discharge valve can be opened at a clearly defined pressure without requiring a pressure sensor for this purpose. Instead the discharge valve is pressed by the medium in the direction of its open position as soon as the opening pressure p2 has been reached through the pressurization of the medium. In a development of this the commencing opening process of the discharge valve is detected by a corresponding sensor system and as a reaction thereto the discharge valve opening process is assisted by an electrical control signal. Discharge valve opening preferably takes place counter to a spring force and/or counter to an electrically brought about closing force predetermining the pressure p2.

It is particularly advantageous if on reaching the opening pressure p2 the discharge valve is opened in a valve chamber associated therewith, said valve chamber being separated from the pressure chamber by a narrow channel. With such a construction on opening the discharge valve the pressures p1 and p2 on either side of the narrow channel are opened, so that the volume flow through the channel corresponding to the volume flow discharged by the discharge valve can be precisely calculated.

Particular preference is given to a development of the method, where the second and third steps of the discharge process are repeated until a desired discharge volume and/or a desired number of cycles is repeated, the repetition preferably taking place with a frequency >20 Hz, particularly higher than >100 Hz or even higher than >1000 Hz. As a result of the rapid opening and closing of the discharge valve there is a discharge characteristic with small droplets. This is advantageous more particularly for dispensers for ophthalmic application, because small droplets when striking the eye of a user do not give rise to a blinking reflex. During the closing of the discharge valve with such a construction an electrical control signal leads to the opening either taking place by an electrical control signal or solely through the fluid pressure p2 of the medium in the valve chamber.

In a further development of the invention the discharge process is preceded by a measuring process for determining the forces acting on a valve body of the discharge valve and/or on a piston of the pressure generator. For moving the valve body or piston there are preferably an electrical valve actuator and/or an electrical pump actuator. As a result of the measuring process prior to the discharge process it is possible to determine which auxiliary forces over and beyond the forces brought about by the actuators such as spring forces or frictional forces act on the valve body or piston and consequently influence the movement of the valve body or piston during the discharge process. The thus established values permit a more precise dosing through a correspondingly adapted opening time period or by compensating the detected forces. The measuring process preferably takes place in a state where there is no liquid in the valve chamber and/or pressure chamber, i.e. prior to the initial filling of the flow path.

The measuring process takes place using a valve measuring device or a pump measuring device, which make it possible to establish the movement period and/or displacement of the valve body or pump piston. Accompanied by the addition of further known parameters, such as e.g. the displacement path or the power delivered by the particular actuator, it is possible to establish which auxiliary forces at which level and in which direction influence the movement of the valve body or piston.

As more particularly frictional forces on the valve body or pump piston are initially significantly higher than after a few strokes, preferably prior to the performance of the measuring process but using the valve actuator or pump actuator several valve body or pump piston strokes are carried out in order to reduce friction.

The measuring process or processes are preferably only performed once when the discharge device is initially put into operation and filing thereof preferably takes place in a non-volatile memory.

The opening time t can vary as a function of the course of a discharge process. However, preferably the opening time t and also the number of cycles is established prior to the start of the discharge process.

The opening time t can be fixed in the factory and the discharge of a predetermined value takes place in that in the aforementioned manner use is made of a flow limiter, which produces a clearly defined volume flow when a predetermined bilateral pressure difference is maintained. However, the opening time t can also be fixed in discharge device-specific or use-specific manner. In such a case it is not necessary to respect a predetermined pressure difference between the two sides of the flow limiter. Instead the actual pressure difference can be detected or calculated by means of detected influencing quantities and the opening time t is fixed as a function thereof.

Thus, in both variants prior to the start of the discharge process the discharge device-specific auxiliary forces acting on the valve body or piston are determined, the determined auxiliary forces being used in the first variant in order to produce the preset pressures p1 and p2 by means of compensating means in the form of a valve actuator and/or a pump actuator. In the second variant the detected auxiliary forces are used for calculating the discharge device-specific pressures p1 and p2 and specifically fix t as a function of said pressures for the discharge device and volume to be discharged.

In a further development of the method the discharge process is preceded by an initial filling process, during which following the opening of the discharge valve by an electrical control signal air present is displaced from the flow path between pressure chamber and discharge opening by means of the pressure generator. Air displacement is necessary so that a clearly defined medium quantity can be discharged during the discharge process. As a result of the discharge valve opening brought about by means of the electrical control signal, air can be removed in a very simple manner, in that the pressure generator reduces the flow path volume and forces the air outwards through the discharge opening. This process can be repeated several times and e.g. by closing the discharge valve or closing an additional non-return valve during the enlargement of the pressure chamber volume it is possible to prevent air reentering the flow path through the discharge opening.

The invention also relates to a method for manufacturing a discharge device, in which the specific parameters of the discharge device during manufacture are measured or established and are stored in a preferably non-volatile memory of said discharge device. The specific parameters are those which can vary in the case of an identical manufacturing method between the individual discharge devices or individual production batches. These specific parameters are determined during manufacture and are subsequently stored in the discharge device memory so that they can be included during a discharge process. The specific parameters can e.g. be frictional forces on a valve body or piston, spring constants of a spring device or different dimensions of the discharge device, such as e.g. cylinder diameters. Preferably these values are individually determined for each discharge device. However, it is also possible to only determine the values for a complete batch, e.g. in each case 100 or 1000 discharge devices, so that in the case of parameters which experience has shown to remain virtually the same throughout a batch expenditure for determining the specific parameters can be kept low.

The stored parameters can be used to keep as small as possible divergences from a desired discharge volume, in that the effect of the divergence with respect to the discharge volume is compensated by other measures. Thus, e.g. an excessive diameter of the connecting channel of the flow limiter between pressure chamber and valve chamber can be compensated by producing a smaller pressure difference between pressure chamber and valve chamber.

### BRIEF DESCRIPTION OF THE DRAWINGS

Further aspects and advantages of the invention can be gathered from the claims, the following description of three preferred embodiments and the attached drawings, wherein show:

FIG. 1A first embodiment of an inventive discharge device with an electrical valve actuator and electrical pump actuator, as well as with a flow limiter.

FIG. 2A second embodiment of an inventive discharge device with electrical valve actuator and manual pump actuator, as well as with a flow limiter.

FIG. 3A third embodiment of a inventive discharge device with electrical valve actuator and manual pump actuator, without a flow limiter.

FIG. 3a A variant of the third embodiment of an inventive discharge device with a flow sensor.

### DETAILED DESCRIPTION OF THE EMBODIMENTS

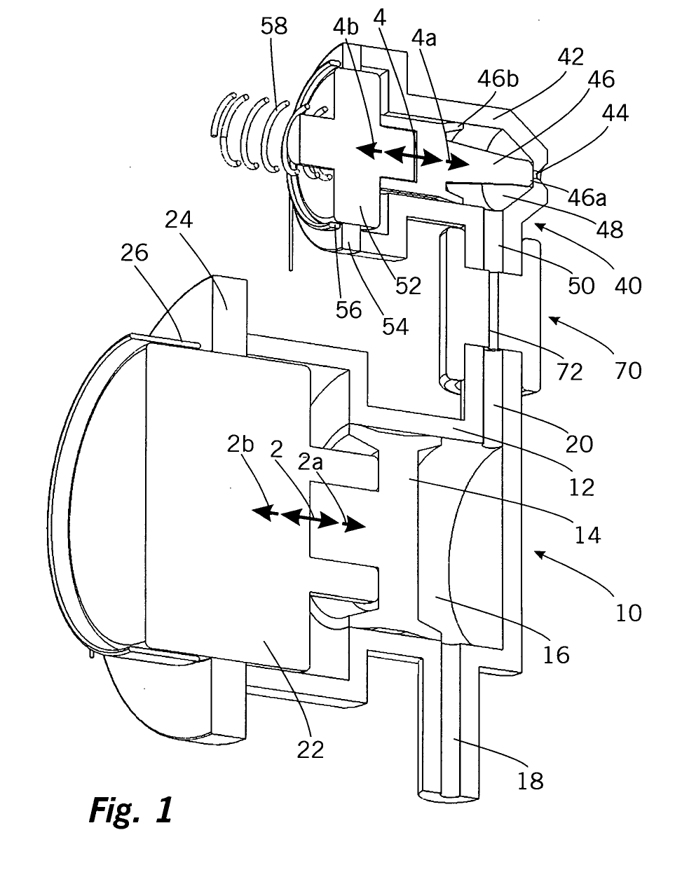

FIG. 1 shows a first embodiment of an inventive discharge device where only the components directly provided for the discharge process are shown. The drawings do not show a casing surrounding the discharge device, the medium reservoir and a control unit for controlling the discharge process, together with actuating key switches connected to the control unit and a display.

The components shown in FIG. 1 comprise a pressure generator 10, a discharge valve unit 40 and a flow limiter 70 linking the pressure generator 10 with the discharge valve unit 40.

The pressure generator 10 has a cylinder 12 within which a piston 14 is movable in movement direction 2. Cylinder 12 and piston 14 together define a pressure chamber 16 whose volume is variable through the movement of piston 14. By means of an intake channel 18 pressure chamber 16 is connected to the not shown reservoir storing the medium. The cylinder is connected via a discharge channel 20 to the flow limiter 70. With respect to the movement direction 2 of piston 14 intake channel 18 and discharge channel 20 issue in mutually displaced manner into pressure chamber 16. Therefore, in the case of a movement of piston 14 in direction 2a, firstly the pressure chamber is separated from intake channel 18, so that the medium can no longer flow back into the reservoir. Only then through a further movement of piston 14 in direction 2a is it possible to pressurize the medium in pressure chamber 16.

Piston 14 is firmly connected to a permanent magnetic core 22, which is mounted on the side of piston 14 remote from pressure chamber 16. Core 22 is positioned within two coils 24, 26 surrounding core 22, the coil 24 representing a pump actuating coil 24 and coil 26 a pump measuring coil 26.

A similar structure to that for the pressure generator 10 exists in connection with the discharge valve unit 40. The latter has a zonally cylindrical valve casing 42, whose front end has a discharge opening 44. Within the valve casing 42 is provided a valve body 46 displaceable in direction 4 and which in its end position in direction 4a closes discharge opening 44 with a closing section 46a. On the opposite side of valve body 46, the latter has an outwardly directed, circumferential lip 46b engaging on the inside of valve casing 42. Together the valve body 46 and valve casing 42 define a valve chamber 48. Valve chamber 48 is connected by an intake channel 50 to the flow limiter 70.

In the same way as piston 14 of pressure generator 10, on its rear side valve body 46 is firmly connected to core 52, which is surrounded by a valve actuating coil 54 and a valve measuring coil 56. Diverging from the design of the pressure generator 10, valve unit 40 additionally has a helical spring 58 by means of which a force is permanently applied in direction 4a to core 52 and valve body 46.

Discharge channel 20 of pressure generator 10 and intake channel 50 of valve unit 40 are indirectly interconnected by means of flow limiter 70, which has a narrow connecting channel 72 through which medium can pass out of pressure chamber 16 into valve chamber 48.

The structure described and shown makes it possible by means of pressure generator 10 to subject the medium which has been delivered by intake channel 18 into pressure chamber 16 with a pressure by forcing piston 14 in direction 2a. As a result the pressure of the medium also rises in valve chamber 48. After opening discharge valve 40 through the displacement of valve body 46 in direction 4b, the pressurized medium can be discharged through discharge opening 44.

The special nature of the discharge device shown is more particularly the design of valve unit 40. Like the discharge valves known from the prior art, valve unit 40 with valve body 46 has a valve body which can be displaced counter to the force of spring 58 as a result of a pressure rise in valve chamber 48 and in this way frees the discharge opening 44. In addition to the force applied to valve body 46 by spring 58 on the one hand and the fluid pressure in valve chamber 48 on the other, force application to the valve body 46 can also take place by means of the valve actuating coil 54. If a current flows through said coil 54, this leads to the formation of a magnetic field through which, as a function of the current flow direction and current intensity in the coil 54, core is supplied with a variable force in direction 4a or 4b. Thus, without the existence of a fluid pressure in valve chamber 48, the valve actuating coil 54 makes it possible to move the valve body in direction 4b and/or despite the presence of a fluid pressure in valve chamber 48 sufficiently high to overcome the spring force of spring 58 to move the valve body 46 in direction 4a, so as in this way to close or keep closed the valve.

Besides the valve actuating coil 54 a valve measuring coil 56 is provided and by means thereof the displacement of core 52 can be detected. As a result of a movement of core 52 a voltage is applied to the terminals of valve measuring coil 56 and can be detected for evaluation purposes. It is possible by means of the valve measuring coil 56 to establish whether the core 52 is being moved and also how rapidly said core 52 is moved.

Like valve unit 40 the pressure generator also has a pump actuating coil 24 and a pump measuring coil 26. The pump actuating coil 24 makes it possible to move core 22 together with piston 14 in direction 2a and then in the opposite direction 2b. In the case of a movement in direction 2a, the entrance 18 to pressure chamber 16 is closed and then the medium is pressurized in said chamber 16 until following the opening of the discharge valve 40 due to the pressure in the valve chamber a discharge process takes place. During the following displacement of piston 14 in direction 2b, a vacuum is produced in pressure chamber 16, which leads to the suction of new medium out of the reservoir as soon as entrance 18 has been freed again by piston 14.

As in the case of valve unit 40 and valve body 46, the movement of the piston is brought about in that a magnetic field is built up by means of the pump actuating coil 24 and as a result force is applied to the permanent magnetic core 22. However, there is no additional spring, unlike in the case of valve 40. Thus, pump actuating coil 24 represents the sole possibility of moving the piston 14 in direction 2a for pressurizing the medium in chamber 16. The pump measuring coil 26 detects the movement of core 22 and consequently makes it possible to establish whether the core 22 has moved and/or how rapidly the core 22 is moving.

Against the background of this construction the discharge process takes place as follows:

As soon as a force has been applied by piston 14 to the medium in pressure chamber 16 in such a way that there is a fluid pressure p1 there, with a delay there is also a rise in the pressure in valve chamber 48 until the lower pressure p2 prevails there. As a result of pressure p2 the valve body 46 is displaced in direction 4b counter to the force of spring 58 and consequently frees the discharge opening 44. The medium in the valve chamber 48 can consequently pass into the environment in the form of abet. The time at which during opening the valve body 46 is displaced is detected by the not shown control unit by means of valve measuring coil 56, which reacts to the movement of core 52 with a voltage applied to its contacts. Optionally the control unit evaluating the voltage takes account in reducing manner to the particular voltage induction which is brought about by the energizing of valve actuating coil 54 and independently of the movement of core 52.

As soon as the desired medium quantity has been discharged following a time interval t, discharge valve 40 is closed, in that through valve actuating coil 54 the valve body is subject to a force acting in direction 4a through which the valve body 46 is pressed against the fluid pressure p2 against valve opening 44, which ends the discharge process.

At the end of the discharge process piston 14 can be moved back into its position shown in FIG. 1, so that a vacuum is formed in pressure chamber 16 through which the medium is sucked back out of the reservoir.

The volume flow discharged through discharge opening 44 is decisively determined by the geometry of flow limiter 70 as part of the flow path with the highest flow resistance and by the pressures p1 and p2 on either side of flow limiter 70. Pressures p1 and p2 remain substantially constant over and beyond the discharge process, because the force applied by the pump actuating coil 24 and therefore the pressure p1 in the pressure chamber remains unchanged and because the discharge valve 40 ensures a constant pressure in valve chamber 48. As a result of the constant pressures p1, p2 the volume flow through the flow limiter, i.e. the volume flowing through the flow limiter per time unit, remains unchanged throughout the discharge process.

As the volume flow is constant, it is only the opening time of discharge valve 40 which determines the quantity of discharged medium. This proportionality makes it possible to achieve the desired discharge volume in that following an easily calculatable or predetermined time period valve 40 is closed again.

In order to be able to discharge a predefined volume using the discharge device shown, a number of procedural variants are possible.

In a first variant the opening time t of the discharge valve is fixed preset for delivering volume V. In order to discharge said volume V within the time period t, it is necessary to obtain a clearly defined volume flow in the flow limiter. This can be achieved if the pressures p1 and p2 or at least the pressure difference p=p1−p2 assumes a predetermined value.

Pressure p1 is decisively dependent on the force application to piston 14 by pump actuating coil 24 and core 22. However, particularly due to the frictional forces between piston 14 and cylinder 12 a force application to the piston by means of pump actuating coil 24 can lead to a differing pressure in pressure chamber 16.

In order to permit the force application through pump actuating coil 24 necessary for achieving the pressure p1, thus according to first variant the frictional forces between piston 14 and cylinder 12 and/or other auxiliary forces leading to imprecisions are determined. For this purpose in a state in which the pressure chamber 16 is still filled with air, piston 14 is transferred from its one end position into its other end position and the time necessary is recorded. The higher the frictional forces acting between piston 14 and cylinder 12, the longer this time. This process is repeated several times to exclude measurement errors. The frictional forces established in this way are used in order to calculate the necessary force application of piston 14 by means of pump actuating coil 24 leading to a pressurizing of the medium in the pressure chamber with pressure p1.

In the same way it is also possible to calculate a correcting force with which the valve actuating coil 54 must act on valve body 46, so that the discharge valve 40 opens at a pressure of the magnitude of the preset value p2. Although the pressure at which the discharge valve 40 opens is decisively dependent on the design of spring 58, the resulting opening pressure can be subject to variation due to the differences in connection with the spring parameters and the frictional forces between valve body 46 and valve casing 42. This can be compensated with a correcting force through an additional force application to valve body 46 by means of pump actuating coil 54.

To be able to evaluate how high this correcting force must be, during the putting into operation of the discharge device by means of the valve actuating coil and the valve measuring coil an analysis of valve 40 takes place. For this purpose valve body 46 is transferred from its closed position into its open position by means of a clearly defined power of actuating coil 54. The time required is established. The greater the auxiliary forces counteracting a displacement the longer said time. On the basis of the analysis results it is possible to calculate a correcting force which in the case of a simultaneous force application to the valve body with the spring force and said correcting force it is ensured that the discharge valve opens at the preset pressure p2.

Since as a result the preset pressures p1 and p2 are precisely maintained, throughout the medium discharge the preset volume flow through the flow limiter is also achieved, so that the predetermined medium volume is discharged in the predetermined time interval t.

In exemplified manner reference is made to the following values. It is predetermined that a volume of 50 æl is to be discharged in an opening period of 7*10−2 sec. In order to achieve this with the dimensioning of the connecting channel 72 of diameter D=0.25 mm, length I=4 mm and an exemplified viscosity of æ=1 mPa·s (water), according to the formula q=p.(úD4)/(128 úæú l) a pressure difference p of 0.3 bar must be present. This pressure difference is obtained by presetting p1=4.3 bar and p2=4 bar.

To obtain these values p1 and p2, in the above-described manner determination takes place of the frictional forces and the spring force divergence, so that by means of the valve actuating coil 54 and pump actuating coil 24 in each case there is a force application to piston 14 and valve body 46 leading to said pressures p1 and p2. It is e.g. possible in the case of an inadequate force of spring 58 to compensate by an additional correcting force in direction 4a brought about by valve actuating coil 54.

In a second variant the volume V to be discharged is preset in fixed form, but this does not apply to the discharge valve opening time t. Instead of carrying out an adaptation of the force application by valve actuating coil 54 and pump actuating coil 24 so as to produce predetermined pressures p1 and p2, through the measuring processes by means of pump measuring coil 26 and valve measuring coil 56 solely the pressures p1 and p2 which actually occur are calculated and can vary between individual discharge devices.

After determining the pressures p1 and p2 by establishing the auxiliary forces acting on valve body 46 and piston 14, the actual discharge device calculates the opening time t necessary to discharge the preset volume.

In exemplified manner reference is made to the following valves: a discharge volume of 50 æl is preset. During the measuring process it is established that the pressure p1=4.2 bar and the pressure p2=4.0 bar. From this and taking account of the dimensioning of connecting channel 72 with a diameter D=0.25 mm and a length I=4 mm, it is established that the flow rate q through connecting channel 72 is in accordance with the aforementioned formula 479 ú 10−6 I/sec. On the basis the discharge device establishes that an opening time t=1.04 ú 10−1 I/sec is necessary for discharging 50 æl.

As a result of these two variants it is possible in spite of specific divergences between discharge devices to reliably discharge a preset medium volume. Independently of the operating mode the explained discharge device on the basis of known pressures p1 and p2 and on the basis of a clearly defined geometry of the flow limiter 70 and characteristics of the medium consequently makes it possible to obtain a discharge process with a constant volume flow. This in turn makes it possible to achieve a precisely settable discharge volume solely through the control of the opening time of discharge valve 40.

As an alternative to the described discharge process where the desired volume is continuously discharged, it is also possible to have a pulsed discharge process, in which in each case following the fixed opening time interval of e.g. 0.5 milliseconds the discharge valve is briefly closed by means of valve actuating coil 54. Immediately following on to this or following an established time period of e.g. 0.5 milliseconds, the force application by valve actuating coil 54 is removed again, so that the discharge valve reopens as a result of the fluid pressure in valve chamber 48. As a result of the fixed opening time period a fixed medium quantity is discharged during each opening process, so that the discharged overall volume can be established through the number of opening processes. The described pulsed discharge of the medium is particularly appropriate ophthalmically, because it makes it possible to produce very small droplet sizes which do not cause blinking on the part of the user.

A particular advantage resulting from the embodiment of FIG. 1 is the easy possibility of displacing air present in the delivered state in the liquid path between the reservoir and discharge opening 44 from the flow path. For this purpose when first put into operation an opening of discharge valve 40 is brought about by valve actuating coil 54, so that a pressure subsequently applied through the pressure generator 10 leads to a flow of air through discharge opening 44. When the piston 14 has reached its stroke end position in direction 2a, discharge valve 40 is closed and the piston is moved back in direction 2b until as a result of the vacuum which occurs through intake channel 18 medium flows out of the reservoir into pressure chamber 16. This process is repeated several times, so that stepwise all the air is removed from the flow path and replaced by medium. The end of this process can be detected by pump measuring coil 26, because the displacement of piston in direction 2a takes place in opposition to an increasing resistance. Thus, there is a significant rise in the time needed for displacing piston 14 as soon as the medium delivered from the reservoir up to this time during piston displacement must traverse the channel 72. On the basis of this information the control unit can estimate to what extent air has already been displaced from the flow path.

For checking the air displacement use can be made of the following method. Firstly by means of valve control coil 54 discharge valve 40 is closed and such a high force is applied to the valve body 46 that even in the case of a fluid pressure p1 in valve chamber 48 the valve does not open. Then the piston 14 is moved from its starting position in FIG. 1 in direction 2a. If all the air has already been displaced from the flow path, a displacement of the piston is only possible up to an intermediate position in which the piston has just passed the intake channel 18 as a result of the incompressibility of the fluid. However, if the piston is movable from said position in direction 2a, this is a sure sign that air is still present in the flow path. In such a case the control unit can open discharge valve 40 in order to allow said air to escape.

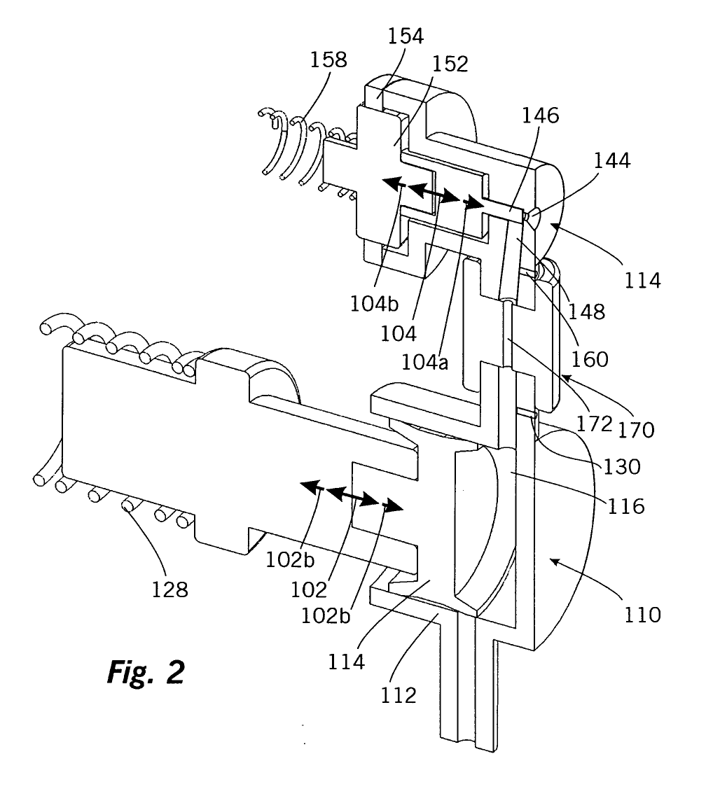

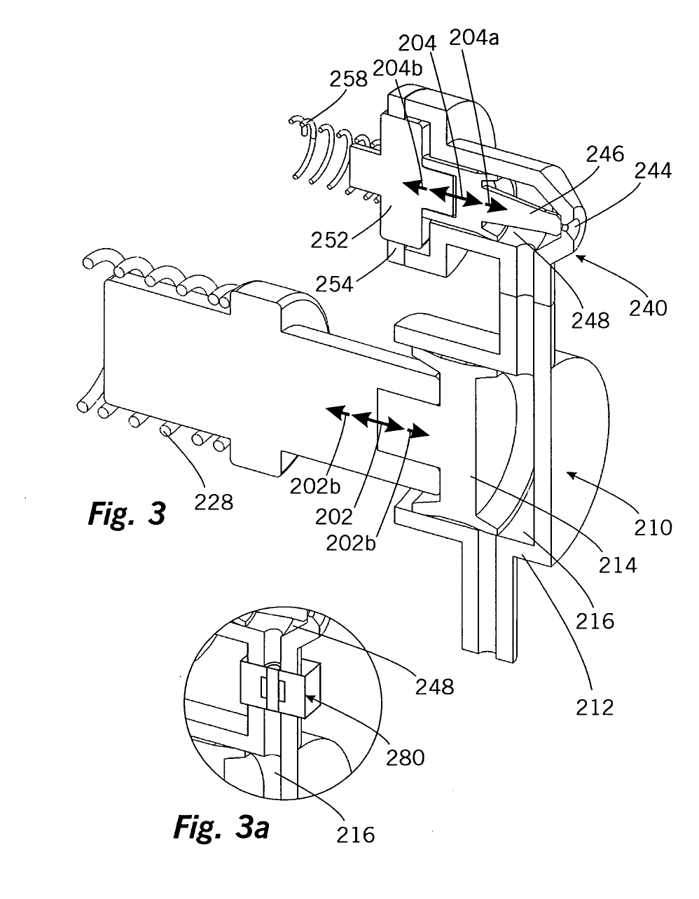

The embodiments of FIGS. 2 and 3 differ from that of FIG. 1 regarding certain aspects. The statements made concerning FIG. 1 apply to the non-differing components.

The pressure generator 110 of the embodiment of FIG. 2 is constructed in order to produce the pressure by means of a spring 128, which has been manually tensioned by a not shown mechanism beforehand by the user by retracting piston 114. With regards to the design of the pressure generator 110 as a piston pump with cylinder 112 and piston 114, this embodiment coincides with the embodiment of FIG. 1. However, there is neither a pump actuating coil nor a pump measuring coil. With regards to the discharge valve unit 140 the essential difference is that the discharge valve cannot be mechanically transferred into an open state by means of a fluid pressure. Valve body 146 has no pressurizing surface and is consequently only deflectable by means of a valve actuating coil 154 counter to the force of spring 158. There is no valve measuring coil accompanying the valve actuating coil 154.

There is a further difference in that both in the vicinity of pump chamber 116 and in the vicinity of valve chamber 148 in each case pressure sensors 130, 160 are provided and permit direct detection of the pressure in chambers 116, 148.

According to the operating procedure of the embodiment of FIG. 2, pressurization of the medium in pressure chamber 116 is brought about by the previously manually tensioned spring 128. As the spring characteristic and the frictional forces of piston 114 on cylinder wall 112 cannot be precisely foreseen, a pressure p1 occurs in pressure chamber 116 which cannot be precisely calculated and can instead only be measured by pressure sensor 130. Accompanied by the interposing of flow limiter 170 said pressure p1 also has an effect on the medium in valve area 148, whose pressure also rises. As soon as a fixed pressure p2, lower than pressure p1, is measured by pressure sensor 160, through the energizing of valve actuating coil 154 discharge valve 140 is opened by the displacement of valve body 146 in direction 104b. The valve body is displaced until the pressure p2 in valve chamber 148 is maintained. During the resulting discharge process the pressures p1 and p2 remain roughly constant and can be detected by pressure sensors 130, 160 which, in the manner described hereinbefore, makes it possible to precisely calculate the flow quantity through flow limiter 170. Even in the case of a change to pressure p1 or pressure p2 during the discharge process, it can be detected by pressure sensors 130, 160, so that the control unit calls on a correspondingly reduced or increased volume flow for calculating the already discharged medium. As soon as the medium quantity to be discharged is reached, discharge valve 140 is closed by the control unit by a force application to valve body 146 in direction 104a.

The embodiment of FIG. 3 is similar to that of FIG. 2. Once again there is a force application to piston 214 by means of a manually tensionable spring 228. However, unlike in the preceding embodiments, there is no flow limiter, so that the pressure p1 arising in pressure chamber 216 as a result of the force of spring 228, directly also prevails in valve chamber 248. Diverging from the construction of FIG. 1, the discharge valve 240 is here constructed in such a way that as a result of the force of spring 258 of discharge valve 240 the opening pressure p2 at which it is solely opened by the fluid pressure of the medium in valve chamber 248 is above the pressure p1. By pressurizing the medium with pressure p1, initially there is a uniform fluid pressure p1 in pressure chamber 216 and valve chamber 248, without a discharge process occurring. The discharge process does not start until as a reaction to a push-button pressure on the part of the user, through the energizing of valve actuating coil 254 valve body 246 is displaced in direction 204b. The discharge process is ended at the end of a preset opening time, in that by discontinuing the energizing of valve actuating coil 254 valve body 246 is again pressed in direction 204a onto discharge opening 244.

This third embodiment does not make it possible to precisely determine the discharged fluid quantity, because the fluid pressure p1 is decisively determined by the force of spring 228 and the specific parameters thereof can differ from the desired parameters. In the case of media where the precise dosage is less important, it is still possible to make use of the embodiment of FIG. 3.

To obtain a more precise dosage, the embodiment of FIG. 3 can be supplemented by a flow measuring device 280, which is e.g. to be positioned between pressure chamber 160 and valve chamber 148, as is diagrammatically shown in FIG. 3a. The flow measuring device 280 makes it possible to directly determine the discharged fluid quantity and by stopping force application of valve body 246 in direction 204b or force application of valve body 246 in direction 204a by means of a corresponding control of the valve actuating coil 254 the discharge can be interrupted on reaching the desired discharge volume.

Alternatively to the construction with a flow measuring device 280, an increase in the discharge precision can also be brought about in that the discharge device control unit memory stores parameters for the specific spring 258 which were predetermined during the manufacturing process. In the same way and in all three embodiments described, it is possible to record data with respect to individual dimensions such as the internal diameter of valve casing 42, the internal diameter of cylinder 12, 112, 212 or the dimensions of channel 72, 172 established at the time of manufacture in a memory of the discharge device, so that account can be taken thereof when calculating the specific discharge process parameters.

1. A discharge device for a liquid pharmaceutical medium, said device comprising
a reservoir for storing the medium,
a pressure generator for pressurizing the medium,
a discharge opening for discharging the medium and
a discharge valve with a valve seat and a valve body which is movable relative to the valve seat between an open position and a closed position,
wherein
an electrical valve actuating device is provided by means of which a force can be applied to the valve body by an electrical valve control current.

2. The discharge device according to claim 1, wherein the discharge valve is constructed in such a way that the valve body can be forced in the direction of its open position by the fluid pressure of the medium in a valve chamber associated with the discharge valve.

3. The discharge device according to claim 1, wherein a valve spring mechanism associated with the discharge valve is provided and by means thereof a spring force can be applied to the valve body in the direction of its closed position.

4. The discharge device according to claim 1, wherein the electrical valve actuating device has
a valve actuating coil provided for producing a magnetic field through the electrical valve control current and
a counterbody movable relative to the valve actuating coil and to which a force can be applied by means of the magnetic field with respect to the valve actuating coil,
wherein
the counterbody or valve actuating coil is fixed relative to the valve body.

5. The discharge device according to claim 1, wherein the valve actuating device has a valve piezoactuator controllable by the valve control current for applying a force to the valve body.

6. The discharge device according to claim 1, wherein valve measuring device is provided and is constructed for detecting a displacement of the valve body relative to the valve seat.

7. The discharge device according to claim 6, wherein the valve measuring device has a valve measuring coil constructed for detecting a movement of a counterbody provided on the valve body.

8. The discharge device according to claim 3, wherein the valve actuating device is constructed for applying a force to the valve body which is higher than the spring force acting in the direction of the closed position.

9. The discharge device according to claim 1, wherein a flow limiter is provided between pressure generator and discharge valve.

10. The discharge device according to claim 1, by additionally comprising a pressure chamber, associated with the pressure generator and whose volume can be reduced by said pressure generator, a valve chamber associated with the discharge valve, and a flow limiter being located between pressure chamber and valve chamber.

11. The discharge device according to claim 1, additionally comprising a flow limiter having a connecting channel with an at least zonally uniform cross-section.

12. The discharge device according to claim 1, wherein the pressure generator is constructed as a positive displacement pump with a volume-variable pressure chamber and a pump actuator by means of which it is possible to influence the pressure chamber volume.

13. The discharge device according to claim 12, wherein the pump actuator is constructed as a manually actuatable pump actuator, which has a pump spring means which can be manually tensioned and is constructed in such a way that following release during its relaxation it brings about a volume reduction of the pressure chamber.

14. The discharge device according to claim 12, wherein the pump actuator is constructed as an electrical pump actuator for modifying the pressure chamber volume by means of an electrical pump control current.

15. The discharge device according to claim 12, wherein the electrical pump actuator
has a pump actuating coil to which a force can be applied for producing a magnetic field through an electrical pump control current and
a counterelement movable relative to the pump actuating coil and to which a force can be applied by means of the magnetic field with respect to the pump actuating coil, and
in which the counterelement or pump actuating coil is so constructed and/or positioned that the pressure chamber volume can be varied through a movement of the counterelement relative to the pump actuating coil.

16. The discharge device according to claim 12, wherein a pump measuring device is provided and constructed for determining the state of the pump actuator.

17. The discharge device according to claim 16, wherein the pump measuring device has a pump measuring coil for determining the position of a component associated with the pump actuator and whose position can be varied for influencing the pressure chamber volume.

18. The discharge device according to claim 1, additionally comprising a pressure sensor provided in a pressure chamber and/or a valve chamber.

19. The discharge device according to claim 1, additionally comprising a flow sensor positioned between a pressure chamber and a valve chamber.

20. The discharge device according to claim 1, additionally comprising a control unit for controlling valve control current and/or a pump control current and/or permitting the evaluation of an output signals of a pump measuring device and/or a valve measuring device.

21. A method for discharging a liquid pharmaceutical medium by means of a discharge device, comprising a discharge process comprising the steps of:
a. applying a pressure p1 within a pressure chamber by a pressure generator to the medium;
b. opening a discharge valve medium discharge purposes and c. closing the discharge valve following an opening time t by an electrical control signal in order to terminate discharge of the medium.

22. The method according to claim 21, wherein in step b, on reaching a preset opening pressure p2 lower than the pressure p1, the discharge valve is directly opened by said opening pressure p2.

23. The method according to claim 21, wherein steps b and c are repeated until a discharge volume and/or a number of cycles is reached, the repetition preferably taking place with a frequency of at least 20 Hz.

24. The method according to claim 21, wherein the discharge process is preceded by a measuring process for determining forces acting on a valve body of the discharge valve and/or on a piston the pressure generator.

25. The method according to claim 21, wherein the opening time t and the number of cycles are fixed prior to the start of the discharge process.

26. The method according to claim 21, wherein the discharge process is preceded by an initial filling process during which following the opening of the discharge valve by an electrical control signal, air is displaced from a flow path between the pressure chamber and a discharge opening by means of the pressure generator.

27. A method for manufacturing a discharge device, according to claim 1, comprising the step of measuring or determining specific discharge device parameters during manufacture and storing their parameters in a memory of the discharge device.

28. The method according to claim 23, wherein the frequency is at least 100 Hz.

29. The method according to claim 23, wherein the frequency is at least 1000 Hz.
